(19) United States
(12) Patent Application Publication
(10) Pub. No.: US 2007/0281738 A1
(43) Pub. Date: Dec. 6, 2007

(54) Communications Terminal Comprising a Multidirectional Camera

(76) Inventors: Gilles Durand, Eragny (FR); Olivier Beune, Meudon (FR); Laurent Vermeglio, Suresnes (FR)

Correspondence Address: MORGAN LEWIS & BOCKIUS LLP, 1111 PENNSYLVANIA AVENUE NW, WASHINGTON, DC, 20004, US

(21) Appl. No.: 10/583,486

(22) PCT Filed: Dec. 17, 2004
(86) PCT No.: PCT/FR04/50726

§ 371 Date: Jul. 26, 2007

(30) Foreign Application Priority Data
Dec. 23, 2003 (FR) 0315433

(51) Int. Cl. H04M 1/00

(52) U.S. Cl. 455/556.1

(57) ABSTRACT

The invention relates to a communication terminal comprising a multi-directional image acquisition system (1″), said image acquisition system (1″) consisting of: image capture means (3″), at least one optical lens (2″) and reflection means (4″) which provide the image to the image capture means (3″). According to the invention, the reflection means (4″) are mounted such as to rotate around the optical axis of the image capture means (3″). The invention is characterised in that the reflection means (4″) are located on the optical path between the optical lens (2″) and the image capture means (3).

The invention relates to a communications terminal comprising a multidirectional camera.

One of the fields of application, not exclusive, of the invention, is that of mobile radiotelephone terminals.

The invention is notably applied, but not exclusively to a terminal operating in a network according to the GSM (Global System for Mobile communications), DCS, PCS or UMTS standards, or even to a DECT (Digital European Cordless Telecommunications) type terminal.

More and more communications terminals are equipped with a camera, generally located on the back of the terminal, and with which the user of the terminal may take a photograph of a subject located in front of him/her. The user may frame the subject while viewing the image of the subject on the display screen of the terminal, before taking the photograph.

When the user wishes to take a photograph of himself/herself, he/she has to look at the back of his/her terminal but can no longer view his/her image on the display screen of the terminal before taking the photograph, and therefore he/she cannot properly frame his/her image.

An image acquisition system 1 is known from the prior art, illustrated in FIG. 1, including an objective consisting of at least one lens 2, of a sensor 3, of a casing 7 and of a flexible electronic connector 10. The image acquisition system is for example located on the top of the casing 11 of the terminal.

The sensor 3 is placed in the casing 7. The lens 2 is placed in front of the sensor 3, in an aperture provided in the wall of the casing 7.

The casing 7 includes a cylindrical protrusion 8 which sinks into the casing 11 of the terminal. The protrusion 8 is approximately vertical when the terminal is its usual position of use. The protrusion 8 is mounted so as to be able to rotate over 180°, while making the system 1 integral with the casing 11 of the terminal.

By rotating the casing 7, the user directs the lens 2 to the front or to the rear of the terminal at will.

The lens 2 is directed towards the subject and forms an image of the subject on the sensor 3 which records this image and transmits it onto the display screen of the terminal via the flexible electronic connector 10. When the user of the terminal wishes to take a photograph of himself/herself, it is sufficient for him/her to turn the system 1 towards him/her.

However the connector 10 is very fragile and subject to repeated handling stresses, it breaks very easily and the image acquisition system 1 then becomes unusable.

A solution of this problem is known from document GB 2,368,992.

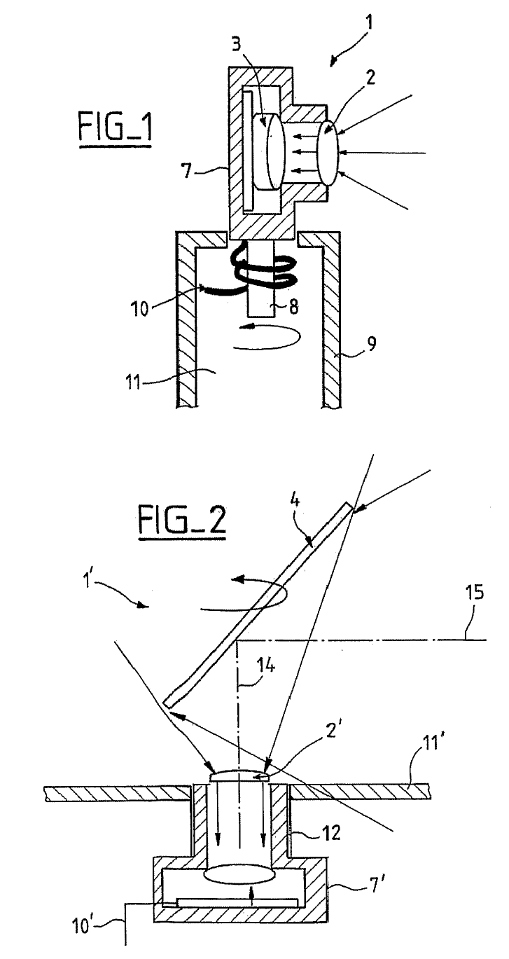

The document describes an image acquisition system 1′ illustrated in FIG. 2. This system 1′ includes an objective consisting of at least one optical lens 2′, a sensor 3′, a mirror 4.

The sensor 3′ is placed in a casing 7′ which includes an aperture bearing the lens 2′. The lens 2′ is directly placed opposite the sensor 3′, and it forms an image of the subject on the sensor 3′.

The casing 7′ of the system 1″ is fixed to the interior of the casing of the terminal, but in such a way that the lens 2′ is flush with the outer surface of the wall 6′ of the terminal.

The mirror 4 is outside the casing 7′ of the system 1′. It is mounted on a support (not shown) which is outside the casing 11′ of the terminal and which may rotate around an axis of rotation, coinciding with the optical axis 14 of the lens 2′ and of the sensor 3′. Thus it may be moved between two determined angular positions, which differ by 180°. The mirror 4 is always tilted by 45° relatively to the optical axis 14 of the lens 2′.

If the system 1′ is located on the top of the terminal, for example, the mirror 4 has an approximately vertical axis of rotation. The system 1′ then has an optical axis 15 which may be moved in a horizontal plane. An image in the front or behind the terminal may be sensed with it, according to whether the mirror 4 is in either one of both predetermined positions.

The images respectively obtained in both of these cases, are shifted by 180° around the axis 14. An electronic circuit then allows the obtained image to be turned in an appropriate direction.

However, this solution has the drawback of requiring a mirror 4′ with a large size relatively to the size of the lens 2′. Indeed, the image is transformed by the lens after the right angle since the mirror 4′ is located in front of the lens 2′. The mirror 4′ is therefore located in the divergence cone of the lens 2′, and because of this, it should have a large size in order to have a field of view with a reasonable angular size.

This solution therefore has the drawback of requiring that more space be provided at the surface of the terminal for a camera topped by a mirror. Further, the mirror is an extremely fragile part. It should be topped by a plastic bubble to protect it. This solution is absolutely not compact.

The object of the invention is to provide a more compact and resistant image acquisition system.

For this purpose, the invention relates to a communications terminal comprising a multidirectional image acquisition system, said image acquisition system comprising image capture means for an, at least one optical lens, and reflection means providing the image to the image capture means; said reflection means being rotatably mounted around the optical axis of the image capture means, characterized in that said reflection means are located on the optical path between the optical lens and the image capture means.

The thereby characterized system is more compact than the known systems because it requires a mirror of smaller size, for a same diameter of the objective.

Indeed, the objective converges the light rays which have crossed it.

The light beam is therefore narrower opposite the objective. It is therefore possible to deflect it by means of a mirror of smaller size, if the mirror is placed downstream from the objective.

Other features and advantages of the invention will become apparent upon reading the following description of a particular embodiment of the invention, given as an illustration and not as a limitation, and of the drawings set forth below.

FIG. 1, already described, illustrates an image acquisition system for a mobile terminal according to the prior art.

FIG. 2 already described, illustrates a second image acquisition system for a mobile terminal, according to the prior art.

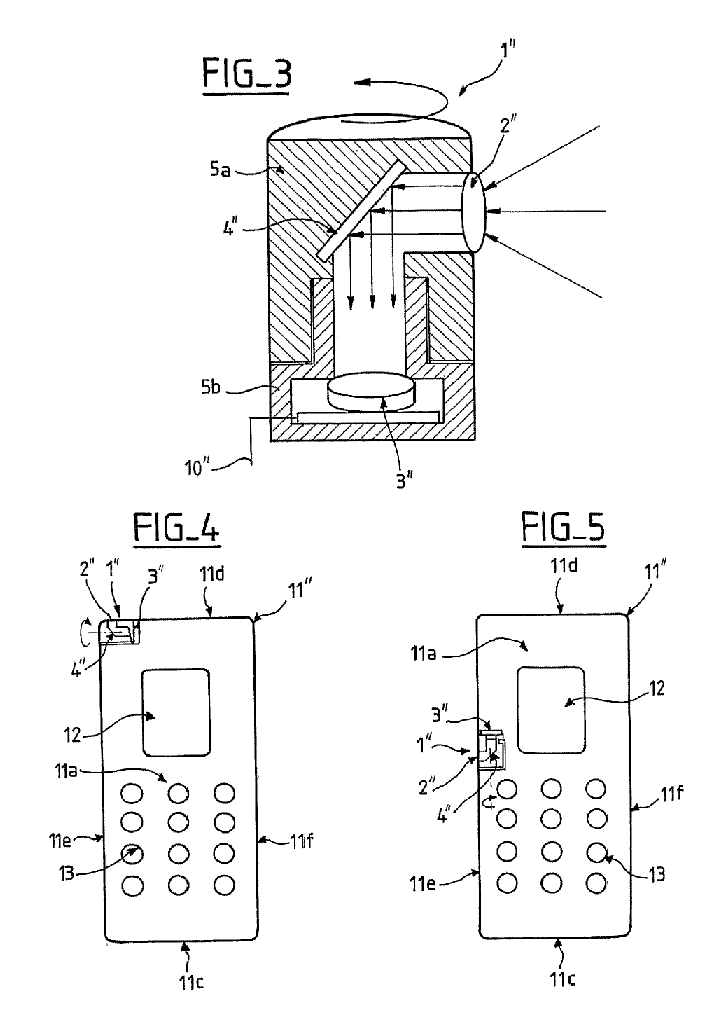

FIG. 3 illustrates an image acquisition system for a mobile terminal, according to the invention.

FIGS. 4 and 5 illustrate two terminals comprising an image acquisition system for a mobile terminal, according to the invention.

The mobile terminal of FIG. 3 comprises an image acquisition system 1″, comprising an image sensor 3″, an objective consisting of at least one optical lens 2″, and a mirror 4′.

The mirror 4″ is located on the optical path between the lens 2′ and the sensor 3″.

The image capture means 3″ are for example a sensor or any other device sensitive to light.

The reflection means 4″ are for example a mirror 4″ or any other light-sensitive device, such as a prism or a metallized plastic surface.

The image acquisition system 1″ is comprised in a cylinder split into two portions: a first portion 5a comprising the lens 2″ and the mirror 4″, and a second portion 5b comprising the sensor 3″ connected on the terminal.

The second portion 5b of the cylinder making up the image acquisition system 1″ is permanently fixed on the terminal.

The first portion 5a of the cylinder making up the image acquisition system 1″ is rotary with respect to the second portion 5b of the cylinder.

Thus, the mirror 4″ and the lens 2″ are rotary with respect to the fixed sensor 3″.

And as the mirror 4″ is located behind the lens 2″ relatively to the subject to be photographed, the mirror is not in the divergence cone of the lens 2″ and has no constraint on size, as this is the case in the prior art.

The cylinder is also able to protect the image acquisition system 1″ from dusts.

Two terminals comprising the image acquisition system 1″ are illustrated in FIGS. 4 and 5.

The illustrated communications terminals comprises a casing 11″ including a front wall 11a, a rear wall 11b, a lower edge 11c and an upper edge 11d, a first side edge 11e and a second side edge 11f.

The lower 11c and upper 11d edges respectively run alongside both front 11a and rear 11b edges of the casing 11″ of the terminal, respectively.

A display screen 12, a keyboard 13 and the image acquisition system 1″ are found on the front wall 11a.

In FIG. 4, the image acquisition system 1″ is for example inserted into a hole provided in the front wall 11a along the upper edge 11d.

In FIG. 5, the image acquisition system 1″ is for example inserted in a hole provided in the front wall 11a along the first side wall 11e.

As the image acquisition system 1″ is very compact, it is possible to insert it along one of the lower 11c, or upper 11d or side 11e edges or even the second side edge 11f, without any risk of damaging it as the mirror, a very fragile part, is protected by the lens located along the edge of the terminal.

Provision may also be made in order not to make the lens flush along the edge of the terminal so as to protect it.

The image acquisition system 1″ may also consist of a single part moulded in plastic in which a sensor 3″ is placed. This plastic part is moulded so as to generate a bubble in order to play the role of the lens 2″; and an oblique portion of which, located opposite the bubble playing the role of the lens 2″, is metallized in order to play the role of a mirror 4″.

1. A communications terminal comprising
a multidirectional image acquisition system, said image acquisition system having image capture means, at least one optical lens and reflection means providing the image to the image capture means; said reflection means being rotatably mounted around the optical axis of the image capture means, wherein said reflection means are located on the optical path between the optical lens and the image capture means.

2. The communications terminal according to claim 1, wherein the image acquisition system is a cylinder split into two portions: a first portion having the lens and the mirror and a second portion having image capture means connected on the terminal.

3. The communications terminal according to claim 2, wherein the second portion of the cylinder is permanently fixed on said terminal.

4. The communications terminal according to claim 2, wherein the first portion of the cylinder making up the image acquisition system is rotary with respect to the second portion of the cylinder.

5. The communications terminal according to claim 1, wherein the image capture means are a sensor or any other light-sensitive device.

6. The communications terminal according to claim 1, wherein the reflection means are a mirror, or a prism, or any other reflecting system of miscellaneous shape and composition.
